(19) United States
(12) Patent Application Publication
(10) Pub. No.: US 2007/0061829 A1
(43) Pub. Date: Mar. 15, 2007

(54) Disc cartridge

(75) Inventors: I-Ching Kao, Taipei County (TW); Hsein-Wen Chao, Taoyuan County (TW)

Correspondence Address: BIRCH STEWART KOLASCH & BIRCH, PO BOX 747, FALLS CHURCH, VA, 22040-0747, US

(73) Assignee: PRODISC TECHNOLOGY INC.

(21) Appl. No.: 11/300,451

(22) Filed: Dec. 15, 2005

(30) Foreign Application Priority Data
Sep. 15, 2005 (TW) 094131920

(51) Int. Cl. G11B 23/03

(52) U.S. Cl. 720/728; 720/734

(57) ABSTRACT

A disc cartridge is used for containing an optical information storage medium. The disc cartridge includes a cover and a carrier. In this case, a first connecting portion is protrusively disposed on the cover. The carrier has an accommodating space and a second connecting portion. The first connecting portion and the second connecting portion are disposed in the accommodating space and connect to each other for assembling the cover and the carrier.

### BACKGROUND OF THE INVENTION

1. Field of Invention

The invention relates to disc cartridge and, in particular, to a disc cartridge for containing an optical information storage medium.

2. Related Art

After the highly development of the digital multimedia, the requirements of the optical information storage medium are increases accordingly. In addition to the common optical information storage mediums, the high capacity optical information storage mediums are disclosed recently. For example, a blue-ray disc (BD) is one of the potential products in the industry.

The thickness of the blue-ray disc is composed of a substrate of 1.1 millimeter and a cover layer of 0.1 millimeter. In practice, the blue-ray disc has serious effects to the qualities of writing or reading when the blue-ray disc is damaged by external factors such as the fingerprints, scrapes, or dusts. Therefore, the blue-ray disc is usually covered with a disc cartridge for protecting the blue-ray disc. When the user wants to access the optical disk drive, he or she must put the blue-ray disc together with the disc cartridge into a optical disk drive.

In the prior technology, various kinds of disc cartridges almost have the same size. Referring to FIG. 1, a conventional disc cartridge 1 has an upper housing 11 and a lower housing 12, and uses locking elements 13 located in the rear side of the lower housing 12 to lock the upper housing 11 and the lower housing 12 and to fix the blue-ray disc B. In another aspect, referring to FIG. 2, a conventional disc cartridge 2 uses an adhesive applied to the connecting portion 23 between an upper housing 21 and a lower housing 22 to seal the connecting portion 23. The object of the disclosed methods is to protect and fix the blue-ray disc B as shown in FIG. 1 and FIG. 2. However, in the conventional disc cartridge, the blue-ray disc B is either not easily taken out or sealed in the disc cartridge. Accordingly, the consumers must buy the blue-ray disc B together with the disc cartridge. If one of the blue-ray disc B and the disc cartridge is damaged, it is the only way to take out the blue-ray disc B by a destructiveness method. Otherwise, the entire disc cartridge including the blue-ray disc is discarded. Thus, not only the usage cost of the consumer is increased, but the raw materials are also wasted due to that the disc cartridge is not reusable.

It is therefore an important subject of the invention to provide a disc cartridge, which is possible of replacing the inside blue-ray disc without destroying the disc cartridge so as to reduce the usage cost of the consumer.

### SUMMARY OF THE INVENTION

In view of the foregoing, the invention is to provide a disc cartridge, which is reusable.

To achieve the above, the invention provides a disc cartridge, which is used for containing an optical information storage medium. The disc cartridge includes a cover and a carrier. In the invention, the cover has a protrusive first connecting portion. The carrier has an accommodating space and a second connecting portion. The first connecting portion and the second connecting portion are disposed in the accommodating space and are connected to each other for assembling the cover and the carrier.

As mentioned above, with comparing with the prior art, the disc cartridge of the invention uses the first connecting portion of the cover to tightly connect with the second connecting portion of the carrier. Thus, the optical information medium positioned in the disc cartridge can be protected from being damaged. Besides, the user can easily separate the cover and the carrier without destroying the disc cartridge. Therefore, when the inside optical information medium is to be replaced, it is unnecessary to destroy the disc cartridge and the optical information medium. Moreover, the object of providing a reusable disc cartridge can be achieved, and the raw materials of the disc cartridge thus would not be wasted.

### BRIEF DESCRIPTION OF THE DRAWINGS

The invention will become more fully understood from the detailed description given herein below illustration only, and thus is not limitative of the present invention, and wherein:

FIG. 1 is a schematic diagram showing the conventional disc cartridge;

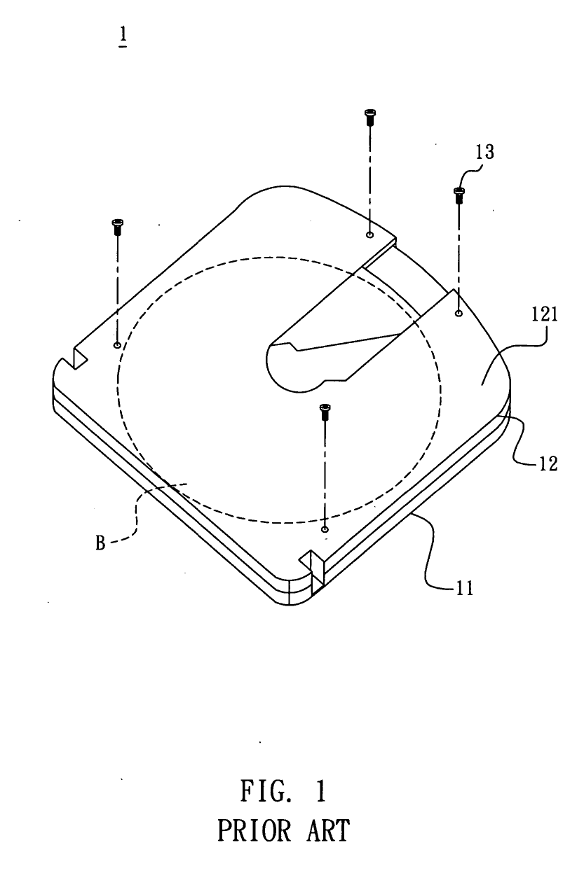

FIG. 2 is a schematic diagram showing the conventional disc cartridge;

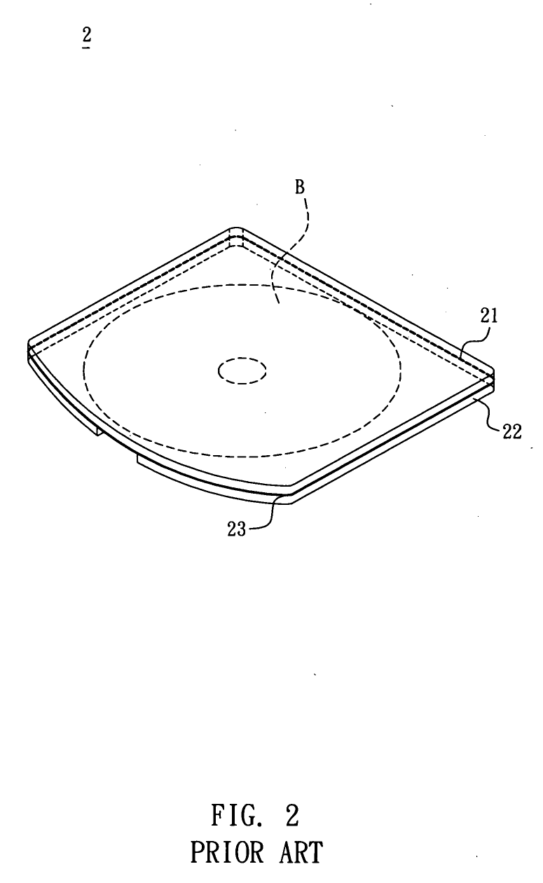

FIG. 3 is an exploded diagram showing a disc cartridge according to a preferred embodiment of the invention;

FIG. 4 is a sectional view of the disc cartridge according to the preferred embodiment of the invention;

FIG. 5 is a sectional view of the disc cartridge according to the preferred embodiment of the invention;

FIG. 6 is a top view of the disc cartridge according to the preferred embodiment of the invention; and

FIG. 7 is a schematic diagram showing the disc cartridge according to the preferred embodiment of the invention, wherein a cover connects with a carrier.

### DETAILED DESCRIPTION OF THE INVENTION

The present invention will be apparent from the following detailed description, which proceeds with reference to the accompanying drawings, wherein the same references relate to the same elements.

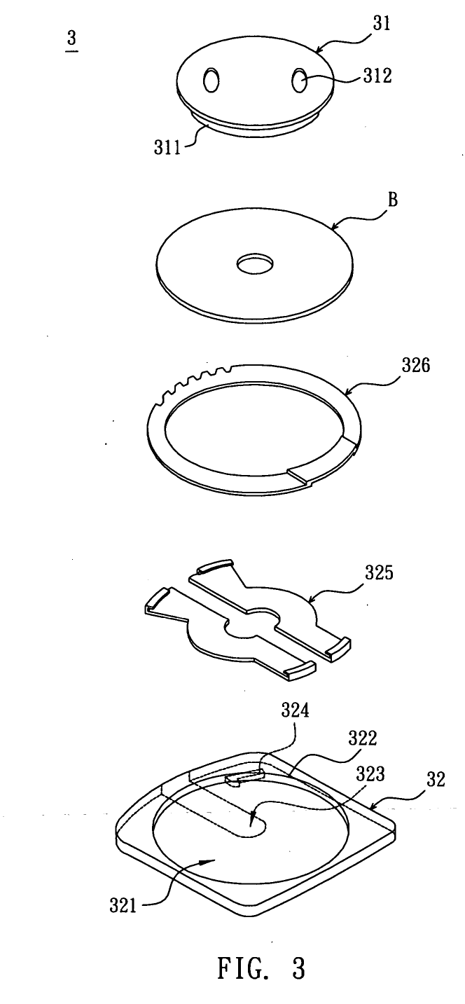

Referring to FIG. 3, a disc cartridge 3 according to a preferred embodiment of the invention, which is used for containing an optical information storage medium B, comprises a cover 31 and a carrier 32. In the embodiment, the optical information storage medium is, for example but not limited to, a blue-ray disc. In addition, a material of the disc cartridge 3 is, for example but not limited to, a plastic material or an acrylic compound.

In the embodiment, referring to FIG. 3, the cover 31 has a protrusive first connecting portion 311 and at least one recess 312 disposed on the cover 31. The user can use his or her hand to rotate, take or place the cover 31 with the recess 312.

Referring to FIG. 3 again, in the embodiment, the carrier 32 has an accommodating space 321 and a second connecting portion 322. The first connecting portion 311 and the second connecting portion 322 are disposed in the accommodating space 321 and are connected to each other for assembling the cover 31 and the carrier 32. In addition, the carrier 32 further has an opening 323 located on an edge of the carrier 32 opposite to the cover 31.

In addition, as shown in FIG. 3, the carrier 32 of the embodiment comprises a shutter latch 324, a shutter 325 and a rotating wheel 326. The shutter 325 is disposed on the shutter latch 324, and the shutter latch 324 is used to control the shutter 325 ordinarily staying in a close condition. The rotating wheel 326 is disposed on the shutter 325, and the optical information storage medium B is disposed on the rotating wheel 326. When the optical information storage medium B are accessed, the shutter latch 324 is opened and the rotating wheel 326 is rotated to open the shutter 325. Accordingly, an optical disk derive can read or write data from the optical information storage medium B through the opening 323.

In the embodiment, the first connecting portion 311 and the second connecting portion 322 can be connected with each other by screwing, locking, or wedging.

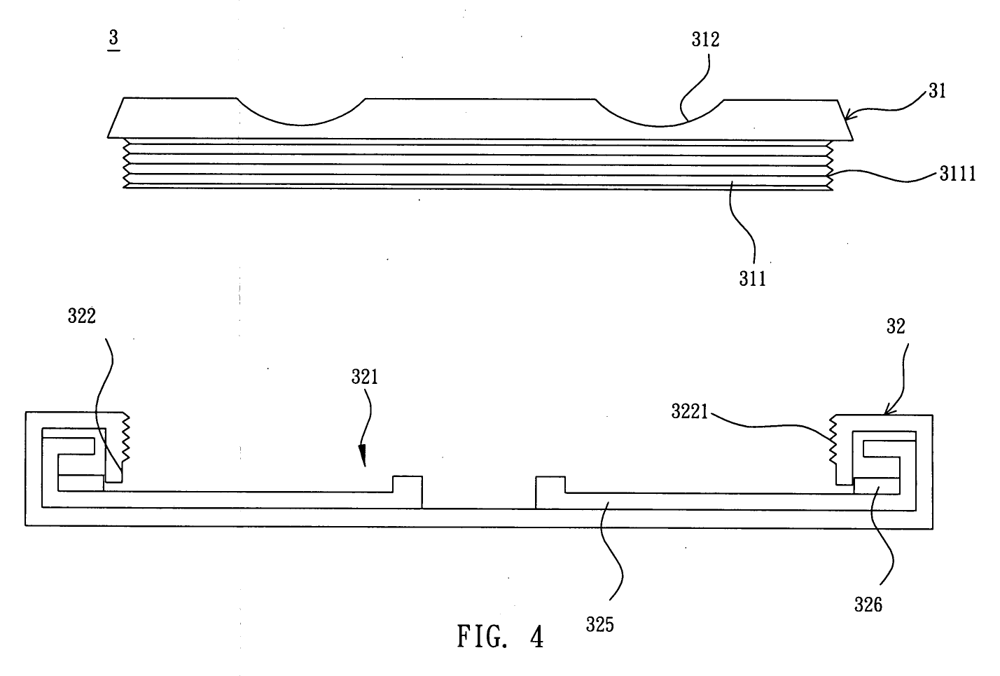

Referring to FIG. 4 showing a disc cartridge 3 according to a preferred embodiment of the invention, the first connecting portion 311 has a first thread 3111, and the second connecting portion 322 has a second thread 3221. When the first thread 3111 and the second thread 3221 are screwed to each other, the cover 31 and the carrier 32 are connected to each other. In the embodiment, the first thread 3111 and the second thread 3221 are respectively a male thread and a female thread, or are respectively a female thread and a male thread.

When a user puts his or her hand on the recess 312, the cover 31 can be rotated to tightly close the cover 31 with the carrier 32, or to open the cover 31. As such a manner, the optical information storage medium B can be fixed and protected, and the user can easily open the cover 31 for replacing the optical information storage medium B.

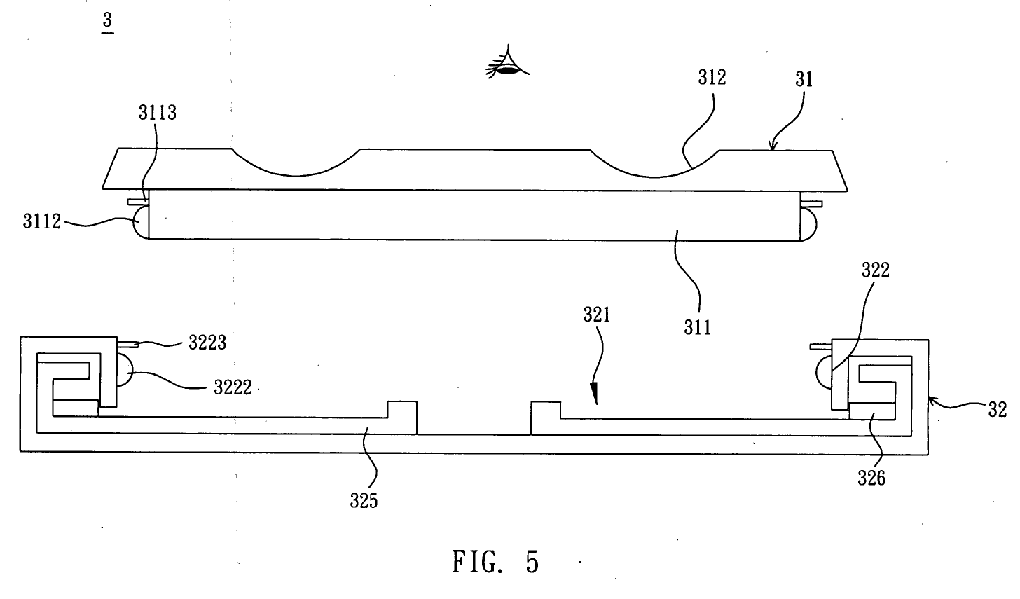

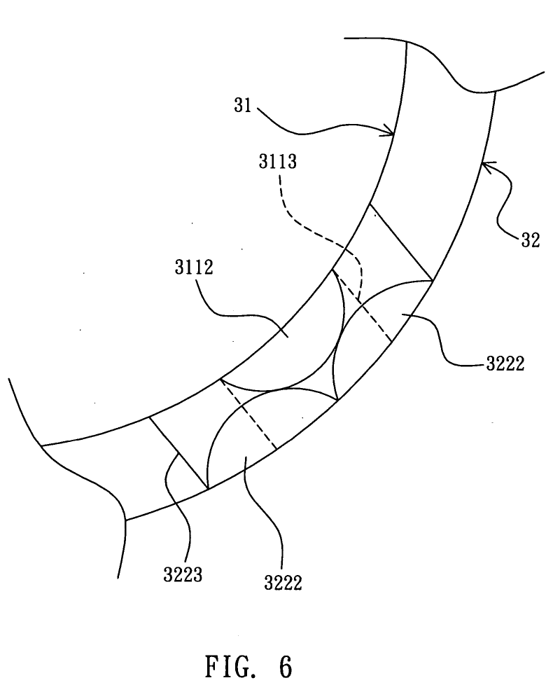

Referring to FIG. 5 showing a disc cartridge 3 according to a preferred embodiment of the invention, the first connecting portion 311 has at least one first protruding portion 3112, and the second connecting portion 322 has a plurality of second protruding portions 3222. In the embodiment, referring to FIG. 6, when the first protruding portion 3112 and the second protruding portions 3222 are locked or wedged to each other, the cover 31 and the carrier 32 are connected to each other. Herein, the arrangements of the second protruding portions 3222 are unlimited. For example, the second protruding portions 3222 can be continuously arranged without an interval or be arranged with a fixed interval or intervals.

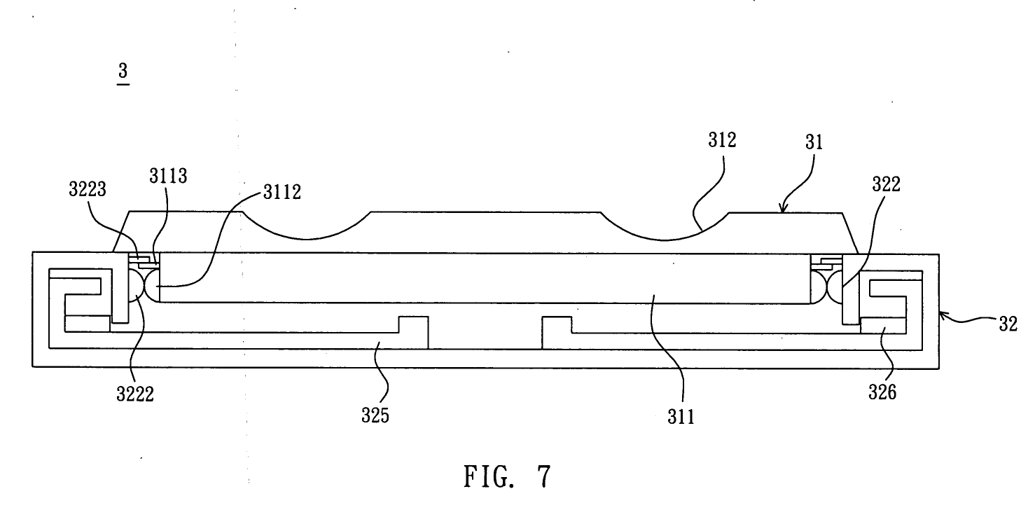

In the embodiment, referring to FIG. 5, the first connecting portion 311 further has at least one first partition 3113, and the second connecting portion 322 has at least one second partition 3223. The second partition 3223 is stacked on the first partition 3113 when the first protruding portion 3112 and the second protruding portions 3222 are wedged to each other. Accordingly, the cover 31 and the carrier 32 can be tightly closed. Thus, the cover 31 and the carrier 32 can be prevent from separating to each other so as to protect the optical information storage medium B. Referring to FIG. 6 and FIG. 7, the positions of the first partition 3113 disposed on the cover 31 and the second partition disposed on the carrier 32 are unlimited. In the current embodiment, for example, the first partition 3113 is disposed on the first protruding portion 3112, and the second partition 3223 is disposed on the second protruding portion 3222.

When a user puts his or her hand on the recess 312 of the cover 31, the first connecting portion 311 of the cover 31 and the second connecting portion 322 of the carrier 32 can be connected to each other. The second partition 3223 is stacked on the first partition 3113 when the first protruding portion 3112 is moved clockwise or counterclockwise to lock or wedge with the second protruding portion 3222. In this case, the cover 31 and the carrier 32 are not only fixed along the horizontal direction, but also can not be separated along the vertical direction. Accordingly, the cover 31 and the carrier 32 can protect and fix the optical information storage medium B, and the user can easily open the cover 31 to replace the optical information storage medium B.

In summary, with comparing with the prior art, the disc cartridge of the invention uses the first connecting portion of the cover to tightly connect with the second connecting portion of the carrier. Thus, the optical information medium positioned in the disc cartridge can be protected from being damaged. Besides, the user can easily separate the cover and the carrier without destroying the disc cartridge. Therefore, when the inside optical information medium is to be replaced, it is unnecessary to destroy the disc cartridge and the optical information medium. Moreover, the object of providing a reusable disc cartridge can be achieved, and the raw materials of the disc cartridge thus would not be wasted.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A disc cartridge for containing an optical information storage medium, comprising:
a cover, which has a protrusive first connecting portion; and
a carrier, which has an accommodating space and a second connecting portion, wherein the first connecting portion and the second connecting portion are disposed in the accommodating space and are connected to each other for assembling the cover and the carrier.

2. The disc cartridge of claim 1, wherein the disc cartridge is made of a plastic material or an acrylic compound.

3. The disc cartridge of claim 1, wherein the cover further has at least one recess, and the recess is disposed on the cover.

4. The disc cartridge of claim 1, wherein the first connecting portion and the second connecting portion are connected by screwing, locking, or wedging.

5. The disc cartridge of claim 4, wherein the first connecting portion has a first thread, the second connecting portion has a second thread, and the first thread and the second thread are screwed to each other.

6. The disc cartridge of claim 5, wherein the first thread is a male thread, and the second thread is a female thread.

7. The disc cartridge of claim 5, wherein the first thread is a female thread, and the second thread is a male thread.

8. The disc cartridge of claim 4, wherein the first connecting portion has at least one first protruding portion, the second connecting portion has a plurality of second protruding portions, and the first protruding portion and the second protruding portions are locked or wedged to each other.

9. The disc cartridge of claim 8, wherein the second protruding portions are continuously arranged without an interval.

10. The disc cartridge of claim 8, wherein the second protruding portions are arranged with a fixed interval.

11. The disc cartridge of claim 8, wherein the first connecting portion has at least one first partition, the second connecting portion has at least one second partition, and the second partition is stacked on the first partition when the first protruding portion and the second protruding portions are wedged to each other.

12. The disc cartridge of claim 8, wherein the first connecting portion has at least one first partition disposed on the first protruding portion, and the second connecting portion has at least one second partition disposed on the second protruding portion.

13. The disc cartridge of claim 1, wherein the carrier further has an opening disposed on an edge of the carrier opposite to the cover.

14. The disc cartridge of claim 1, wherein the carrier comprises:
a shutter latch;
a shutter, which is disposed on the shutter latch; and
a rotating wheel, which is disposed on the shutter.
